(19) United States
(12) Patent Application Publication
(10) Pub. No.: US 2014/0245368 A1
(43) Pub. Date: Aug. 28, 2014

(54) SMART RECEIVER FOR MASHUP SERVICE BASED ON CONVERGENCE AND RECEIVING METHOD THEREOF

(71) Applicant: JIWU MEDIA CO., LTD., Gwacheon-Si (KR)

(72) Inventors: Yong Soo Park, Seoul (KR); Jong Seong Lee, Yongin-si (KR)

(73) Assignee: JIWU MEDIA CO., LTD., Gwacheon-Si (KR)

(21) Appl. No.: 13/889,302

(22) Filed: May 7, 2013

(30) Foreign Application Priority Data
Feb. 28, 2013 (KR) 10-2013-0022269

(51) Int. Cl. H04N 21/643; H04N 21/61; H04N 21/81; H04N 21/478

(52) U.S. Cl. CPC H04N 21/64322; H04N 21/478; H04N 21/6175; H04N 21/8173
USPC 725/110

(57) ABSTRACT

A smart receiver for a mashup services based on convergence includes a hardware platform which receives a digital broadcast and supports an added service, a smart receiver hardware module which supports a multimedia function of the hardware platform and a mashup service, and a smart receiver software module which supports the multimedia function and the mashup service so that a digital broadcast is received in real time via a broadcast tuner. A software module and a UX (user experience design), both of which enable access to a CDN (contents delivery network) server for a massive data mashup service, are provided in order to overcome a problem with the related art, i.e. an existing system including a smart TV and an IP STB (Internet protocol set-top box) cannot directly support a mashup service, so that a user can use the mashup service at any time.

### CROSS REFERENCE TO RELATED APPLICATION

The present application claims priority from Korean Patent Application Number 10-2013-0022269 filed on Feb. 28, 2013, the entire contents of which application are incorporated herein for all purposes by this reference.

### BACKGROUND OF THE INVENTION

1. Field of the Invention

The present invention relates to a smart receiver for mashup services based on convergence, and more particularly, to a smart receiver for mashup services based on convergence and a smart receiving method thereof, in which a software module and a UX (user experience design), both of which enable access to a CDN (contents delivery network) server for a massive data mashup service for authentication and resultant services, are provided in order to overcome a problem with the related art, i.e. an existing system including a smart TV and an IP STB (Internet protocol set-top box) cannot directly support a mashup service, so that a user can use the mashup service at any time.

2. Description of Related Art

In general, mashup refers to a technology that creates a new derivative work, such as software, a service and a database, using information and a service provided on the web. The mashup indicates a web site or application that provides one service by combining contents provided by a number of information sources as in the case in which a search-related API (application programming interface) published by Google, a map-related API and other several pieces of web service information are combined together in order to be applied to the dealing of real estates.

According to the related art, a method and apparatus for supporting mashup services are disclosed. This method includes the steps of: receiving a mashup service application that is provided from the outside; acquiring and managing an authentication key corresponding to the provided mashup service application; and executing the provided mashup service application using the acquired authentication key. Therefore, as is disclosed in this method of the related art, the authentication key value with which the mashup service is to be properly operated using an open API is stored and managed, so that a user can use a variety of web services.

### RELATED ART DOCUMENT

Korean Patent Pub. No. 10-2009-0024401 (Mar. 9, 2009)

The information disclosed in the Background of the Invention section is only for better understanding of the background of the invention, and should not be taken as an acknowledgment or any form of suggestion that this information forms a prior art that would already be known to a person skilled in the art.

### BRIEF SUMMARY OF THE INVENTION

In order to overcome the problem with the related art, i.e. an existing system including a smart TV and an IP STB (Internet protocol set-top box) cannot directly support a mashup service, a smart receiver for mashup services based on convergence is required to be improved in such a fashion that a software module and a UX (user experience design), both of which enable access to a CDN (contents delivery network) server for a massive data mashup service so as to be authenticated and serviced thereby, are provided, so that a user can use the mashup service at any time.

Various aspects of the present invention provide a smart receiver for mashup services based on convergence and a smart receiving method thereof, in which a software module and a UX, both of which enable access to a CDN server for a massive data mashup service so as to be authenticated and serviced thereby, are provided in order to overcome a problem with the related art, i.e. an existing system including a smart TV and an IP STB cannot directly support a mashup service, so that a user can use the mashup service at any time.

In order to overcome the foregoing problem and to fulfill the requirements, also provided are a smart receiver for mashup services based on convergence and a smart receiving method thereof, in which a smart receiver software module which can receive real time digital broadcasts via a hardware platform, which has a hardware module for receiving digital broadcasts and supporting added services, and a tuner are provided. The smart receiver software module has Android OS (operating system) adapted and optimized to the smart receiver. The hardware platform provides UI/UX (user interface/user experience design) set for digital TV broadcast services, an application used for playing media and for the smart receiver and a user interface.

In an aspect of the present invention, the present invention provides a smart receiver for mashup services based on convergence and a smart receiving method thereof.

The smart receiver for mashup services based on convergence includes: a hardware platform which receives a digital broadcast and supports an added service, the digital broadcast being one selected from among ATSC (advanced television system committee), ISDB-T (integrated services digital broadcasting-terrestrial) and DTMB (digital terrestrial multimedia broadcast) type digital broadcasts; a smart receiver hardware module which includes an HDMI (high definition multimedia interface) port, a USB host, an Internet connection section, an S/PDIF (Sony/Philips digital interface format) output or so on, which realizes a set of hardware suitable for a multimedia function of the hardware platform and mashup services, the smart receiver hardware module supporting added services; and a smart receiver software module which supports an IP network RTSP (real time streaming protocol) service, an HTTP (hypertext transfer protocol) streaming service, HLS (HTTP live streaming) type IP streaming service, an EPG (electronic program guide) service which receives and updates various pieces of information and monitors searching and changing of information, closed captions, PSIP/SI (program and system information protocol/system information), videos, audios or the like.

In an embodiment of the smart receiver, the software module of the smart receiver may have Android OS adapted and optimized to the smart receiver in order to improve the booting speed of the smart receiver and the channel change speed so as to match those of digital TVs, so that a media explorer does not operate every time during booting or when data is stored.

In an embodiment of the smart receiver, the hardware platform may have a user interface for the smart receiver, which includes a home UI/UX simplified for digital TV broadcast services, a media playing application (app), an intuitive menu interface using OpenGL ES (OpenGL for embedded systems), a software upgrade function (manual, automatic and/or scheduled) and an application for a smart receiver (such as a direct DMB (digital multimedia broadcasting) application, a direct EPG management application, a gallery image application, a video resolution management application, or a closed caption application).

In an embodiment of the smart receiver, the hardware platform may include a framework with which mashup services can be used, a framework for the management of a contents hub request, and a UX/UI for mashup services. The frameworks include a media framework, an eco-system interlocked framework, a UX/UI framework and a digital broadcast service framework.

In an embodiment of the smart receiver, the framework may be provided for the management of the contents hub request. The framework stores accounting information and user information requested in mashup services, copes with a processing request for the accounting information and the user information, manages services, manages metadata, and manages and diagnoses resources of the smart receiver and prevents service collision by including a framework module which executes user authentication and service access. The UI/UX includes an application with which the user can use a mashup service at any time.

<<Also provided is a smart receiving method for mashup services based on convergence. The method includes the following steps of: accessing a server for the mashup service via a communication port; supporting receiving a digital broadcast and supporting an added service using a hardware platform after accessing the server; and supporting IP network RTSP (real time streaming protocol), HTTP (hypertext transfer protocol) streaming and HLS (HTTP live streaming) type IP streaming services, a VOD (video on demand) service, an EPG (electronic program guide) service, closed captions, PSIP/SI (program and system information protocol/system information), videos and audios using a software module of the hardware platform, so that the digital broadcast is to be received in real time.

In an embodiment, the step of receiving the digital broadcast and supporting the added service after accessing the server may include dividing meta-information for using the mashup service, processing EPG (electronic program guide) service data and displaying UI/UX (user interface/user experience design) for constructing an IP streaming channel. A corresponding service is selected and mashup data is processed via the UI/UX.>>

The present invention has the following advantageous effects.

First, the smart receiver for mashup services based on convergence according to the present invention is provided with a software module and a UX, both of which enable access to a CDN server for a massive data mashup service so as to be authenticated and serviced thereby, so that a problem with the related art, i.e. an existing system including a smart TV and an IP STB cannot directly support a mashup service, is overcome and a user can use the mashup service at any time.

Second, the smart receiver for mashup services based on convergence includes a smart receiver software module which can receive real time digital broadcasts via a hardware platform and a tuner. The hardware platform has a hardware module which receives digital broadcasts and supports added services. The smart receiver software module has Android OS adapted and optimized to the smart receiver.

Third, the hardware platform provides a UI and a UX for a digital TV broadcast service, an application user interface which is used for playing media files and the smart receiver.

Fourth, the smart receiver for mashup services based on convergence constructs a distribution environment, in which anyone, such as a person or a middle/small sized company, can develop, share and consume a mashup service based on contents using an open contents API and an OPMD (one-person multi-device) media server for mashup services in a bidirectional convergence media environment, so that the use of the mashup service can be increased.

Fifth, the smart receiver for mashup services based on convergence can receive powerful broadcast convergence type contents services which are different those of other receivers, thanks to association of broadcast contents and mashup services. This provides people with chances to more easily contact various video contents, so that generations who can access video contents services are not limited to a specific generation and a variety of generations can access these services.

Sixth, the smart receiver for mashup services based on convergence can provide high-quality smart eco-system services using video and audio systems which are more powerful than common home video and audio systems, and can be linked/coupled to a variety of expansion devices, such as a querty remote controller, a tablet PC, a smartphone and an external memory device.

Seventh, the smart receiver for mashup services based on convergence makes it possible to receive high-quality video contents using an existing digital TV which without replacing an expensive smart TV. In addition, due to the software upgrade function of the smart receiver, it is possible to receive newest OS (operating system) and applications, which is advantageous.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is $FIG. 1 is a block diagram showing an entire system configuration for mashup services according to the present invention;

FIG. 2 is a block diagram showing a process in which an open eco-system API platform according to the present invention provides a service;

FIG. 3 is a block diagram showing a software construction of a smart receiver for mashup services according to the present invention;

FIG. 4 is a block diagram showing a hardware construction of the smart receiver for mashup services according to the present invention;

FIG. 5 is a block diagram showing a use mode construction of the smart receiver for mashup services according to the present invention;

FIG. 6 is a picture showing an example of a user interface of a smart receiver application;

FIG. 7 is a picture showing an example of a user interface of a smart receiver watching screen; and

FIG. 8 is a picture showing an example in which a smartphone is used as a remote controller of a smart receiver.

### DETAILED DESCRIPTION OF THE INVENTION

Reference will now be made in detail to various embodiments of the present invention, examples of which are illustrated in the accompanying drawings and described below.

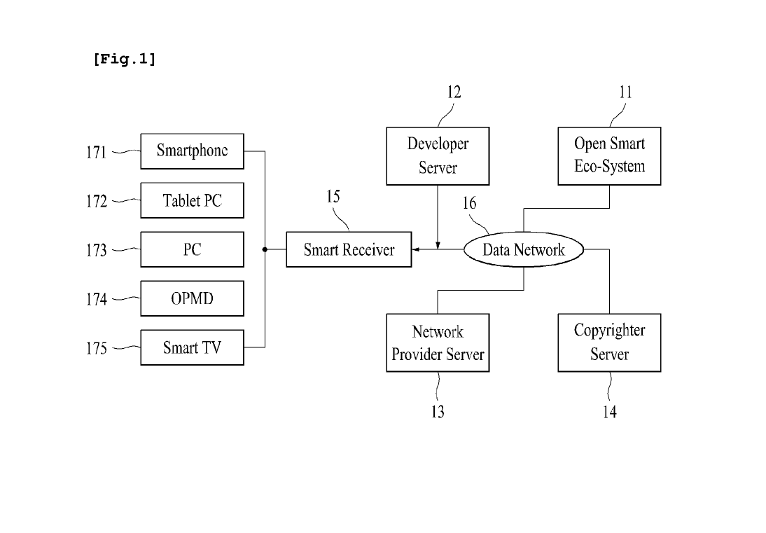

FIG. 1 is a block diagram showing the entire system configuration for mashup services according to the present invention. Provided is an open smart eco-system 11 which includes a cooperative media server system which performs a practical key role in the mashup service and an open contents API.

The open smart eco-system 11 includes an open contents API developer support server which constructs a development forum for supporting the development of devices and application using open contents standards; a contents hub system which collects and supplies contents and metadata continuously supplied from terrestrial broadcasting companies; a user management server, or a system, with which consumers can pay for the use of contents; a provider management server which manages providers of the open smart eco-system; and an open mashup contents market, or a market, which distributes added services that utilize the open smart eco-system using the open contents API.

Here, the contents hub server is interlocked with a broadcaster CMS (contents management system), a network provider system such as a CDN, and multimedia devices, and carries out a legal authentication process using the open contents API. The provider management server collects and exactly calculates the degrees of contribution of providers who have contributed until end users are provided with contents, such as network providers or device providers, utilizes the calculated results for revenue sharing. The provider management server reflects the calculated results on an user-centered accounting policy considering an OPMD (one-person multi-device) service. Thus, when the same user utilizes a piece of content which he/she paid for already in the OPMD environment, the content can be utilized without being double charged.

Also provided is a developer server 12 which develops and distributes software and added services, which enable access to the open smart eco-system utilizing the open contents API, to a variety of devices, such as tablet PCs (personal computers), smartphones or smart receivers.

Also provided are a network provider server 13 with which a provider, such as an IDC or CDN, provides a contents delivery network and a copyrighter server 14 with which a broadcasting company, such as KBS (Korean Broadcasting System), MBC (Munhwa Broadcasting Corporation), SBS (Seoul Broadcasting System) or EBS (Educational Broadcasting System), or a copyrighter provides contents.

Also provided is a data network 16 which provides routes for communication to the open smart eco-system 11, the developer server 12, the network provider server 13, the copyrighter server 14 and a smart receiver 15. The data network 16 can be implemented, for example, as the Internet.

In the foregoing system environment, consumers can receive and enjoy contents that are provided via a variety of devices, such as a smartphone 171, a tablet PC 172, a PC 173, an OPMD 174 and a smart TV 175.

A contents developer server can be connected to the copyrighter server 14. Contents developers may include broadcasting companies and small contents providers which produce broadcast contents to be broadcast and supply such broadcast contents to the KBS, MBC, SBS or EBS. When the network provider server 13 is also operated such that revenue sharing is set depending on contribution to the open smart eco-system 11, the number of network providers is increased, thereby distributing the burden of the network cost.

Therefore, broadcasting contents meta-information and platform standard information of broadcasting contents information are transmitted and received between the copyrighter server 14 and the data network 16. Broadcasting contents and broadcast-added services are transmitted and received between the data network 16 and the network provider server 13. Final contents and added services are delivered between the data network 16 and the smart receiver 15 through the open contents API such that consumers can enjoy final contents and added services. Broadcasting contents-added service developers continuously develop added services utilizing the open contents API and continuously update new versions. In addition, data communication is carried out between the open smart eco-system 11 and the data network 16.

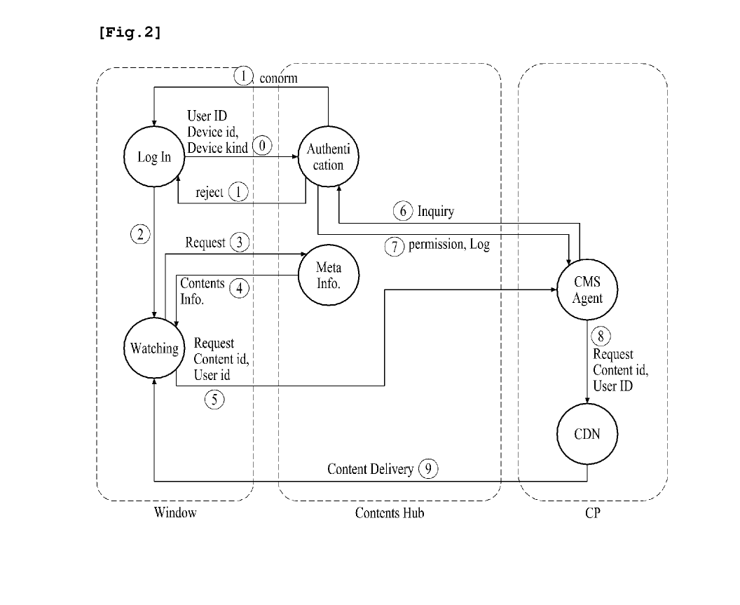

FIG. 2 is a block diagram showing a process in which an open eco-system API platform according to the present invention provides a service. A contents aggregator, a broadcaster, a network provider and a developer perform their own roles, and revenue sharing is made depending on their contribution. In the CP block, \textcircled{8} indicates what is newly generated by a new provider, and \textcircled{1}, \textcircled{2}, \textcircled{3}, and \textcircled{4} in the window Block indicate the route of the Internet.

A description will be given below of a smart receiver based on convergence, which performs the key role in the mashup service according to the present invention.

Due to convergence of broadcasting contents and a mashup service, the smart receiver based on convergence can be provided with stronger and more powerful services than other receivers. The smart receiver according to the present invention provides an advantage in that users can more easily contact a variety of video contents since most people contact video contents via home displays at the present. In addition, generations who can access video contents services are not limited to a specific generation, and a variety of generations can access these services. In addition, since Android OS (operating system) using open resources is recently applied, it is possible to reduce the cost of development and increase compatibility with other mobile devices, and the smart receiver can be supported with a variety of applications (apps).

The smart receiver based on convergence according to the present invention makes it possible to receive high-quality smart services at a low cost using an existing home display by only purchasing the smart receiver without replacing the display. In addition, due to the software upgrade function of the smart receiver, it is possible to receive newest software, such as an OS, mashup services and applications, which is advantageous.

The smart receiver based on convergence according to the present invention has scalability due to its ability to be associated or coupled with peripheral devices. In particular, in conjunction with the desire of users to purchase a better display and a better audio system in order to properly enjoy high-quality video contents in the use of mashup services, a control device such as a qwerty RCU (remote control unit) and a variety of devices using a USB (universal serial bus) host function of a smart receiver can be advantageously used.

The smart receiver based on convergence according to the present invention can acquire contents at various places via connection with expanded mobile devices, and cope with situations free from the constraints of time and place. It is possible to escape from the constraints of time and place by connecting contents to mobile devices based on the adaption of Android OS to the smart receiver and the scalability of the network. For example, when a user who was watching video content from a mashup system at home cannot keep watching the content because of an urgent business or an appointment, the user can continuously watch the content using a mobile device (e.g. a smartphone, a tablet PC, or a mobile instrument) at anytime and anyplace based on an OPMD service.

When a user started watching a broadcast program from the middle using a traditional broadcasting receiver, it is difficult for the user to watch the former part of the broadcast program. In contrast, a user of the smart receiver based on convergence according to the present invention has excellent accessibility provides because he/she can search for and watch desirable content at any time. In addition, due to the use of the newest open OS and the development of hardware, access to expanded device is easy. It can also be easily combined with a HDMI (high definition multimedia interface) dongle type receiver, a TV-embedded smart receiver, or the like.

The smart receiver based on convergence according to the present invention includes a software construction, a hardware construction and a user interface, which will be described in detail as follows.

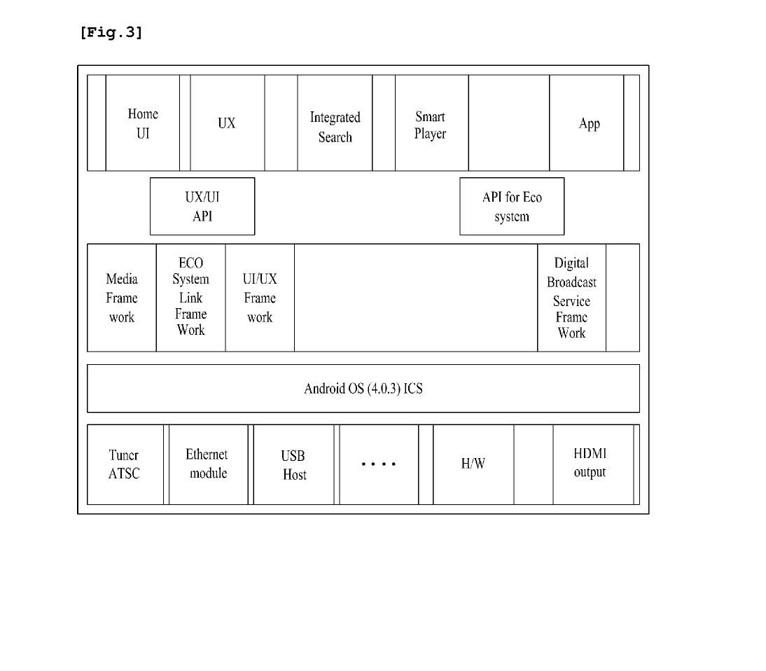

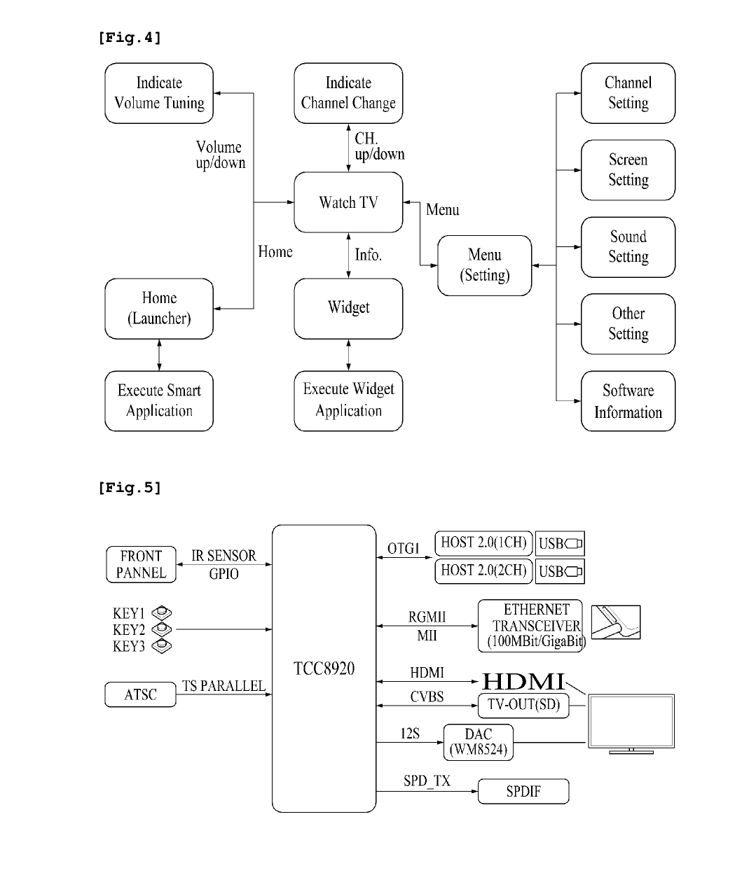

FIG. 3 is a block diagram showing a software construction of a smart receiver for mashup services according to the present invention, FIG. 4 is a block diagram showing a hardware construction of the smart receiver for mashup services according to the present invention, and FIG. 5 is a block diagram showing a use mode construction of the smart receiver for mashup services according to the present invention.

In the smart receiver for mashup services based on convergence, the hardware module of the smart receiver includes a hardware platform which receives ATSC (advanced television system committee), ISDB-T (integrated services digital broadcasting-terrestrial) and DTMB (digital terrestrial multimedia broadcast) type digital broadcasts, and supports added services. The hardware module also includes an HDMI port, a USB host, an Internet connection section (Ethernet, WiFi), an S/PDIF (Sony/Philips digital interface format) output and the like, which embody hardware suitable for a multimedia function of the hardware platform and mashup services, in order to support added services.

In addition, the software module of the smart receiver supports an IP network RTSP (real time streaming protocol) service, an HTTP (hypertext transfer protocol) streaming service, an HLS (HTTP live streaming) type IP streaming service, an EPG (electronic program guide) service which receives and updates various pieces of information and monitors searching and changing of information. The software module also supports closed captions, PSIP/SI (program and system information protocol/system information), videos (HD/SD MPEG-2 (HD/SD: high-definition/standard-definition, MPEG: motion picture experts group), H.264), audios (AAC-LC (advanced audio coding-low complexity), AAC-LC+SBR (advanced audio coding-low complexity+spectral band replication) Level 2, AAC Level 2, AAC-HE (advanced audio coding-high efficiency), Dolby Digital), multi-format contents decoding, MPEG still image decoding, WMA (Windows media audio) and the like. In this fashion, a real time digital broadcast can be watched via ATSC, ISDB-T and DTMB type tuners

In the smart receiver which receives real time broadcasts, the software module of the smart receiver has Android OS which is adapted and optimized to the smart receiver in order to improve the booting speed of the smart receiver and the channel change speed so as to match those of digital TVs. This can also prevent a media explorer from operating every time during booting or when data is stored.

The hardware platform has a user interface for a smart receiver, which includes a home UI/UX simplified for digital TV broadcast services, a media playing application (app), an intuitive menu interface using OpenGL ES (OpenGL for embedded systems), a software upgrade function (manual, automatic and/or scheduled) and an application for a smart receiver (such as a direct DMB (digital multimedia broadcasting) application, a direct EPG management application, a gallery image application, a video resolution management application, or a closed caption application).

Furthermore, the hardware platform includes a framework with which mashup services can be used, a framework for the management of a contents hub request, and a UX/UI for mashup services. The frameworks include a media framework, an eco-system interlocked framework, a UX/UI framework and a digital broadcast service framework.

The framework is provided for the management of the contents hub request, and stores accounting information and user information requested in mashup services, copes with a processing request for the accounting information and the user information, manages services, manages metadata, and manages and diagnoses resources of the smart receiver and prevents service collision by including a framework module which executes user authentication and service access. The UI/UX includes an application with which the user can use a mashup service at any time.

The above-described smart receiver based on convergence basically has the following specification.
Hardware platform which supports ATSC, ISDB-T and DTMB type digital broadcasts and added services
Receiver hardware module which supports added services: The receiver hardware module basically includes an HDMI port, two or more USB hosts and Internet connection terminals (Ethernet, WiFi), an S/PDIF output and so on in order to embody hardware suitable for a multimedia function and a mashup service.
Smart receiver software module which supports an EPG service, closed captions, PSIP/SI, videos, audios and the like: Newest Android OS is adapted and optimized to the smart receiver. A media explorer does not need operate every time during booting or when data is stored, thereby maintaining rapid booting and processing speed. Mobile OS is adapted to the stationary smart receiver by modifying functions, settings and so on. The booting speed of Android OS is improved so that it is suitable for the smart receiver which receives broadcasts in real time. The channel change speed is increased to be similar to that of a digital TV.
User interface for the smart receiver
Framework with which a mashup service can be used

The above-described smart receiver based on convergence supports the following technologies so that digital broadcast can be watched in real time via a broadcast tuner.
IP network RTSP, HTTP streaming and HLS type IP streaming
EPG services: Information is received and updated. Searching and changing of information are monitored.
Closed caption
PSIP/SI
Videos: HD/SD MPEG-2, H.264 and other formats
Audios: AAC-LC, AAC-LC+SBR Level 2, AAC Level 2, AAC-HE, Dolby Digital and others
Multi-format contents decoding
MPEG still image decoding, WMA
IP network RTSP, HTTP streaming

In the above-described smart receiver based on convergence, frameworks for the smart receiver suitable for mashup services are as follows:
Framework with which mashup services can be used: The framework for managing and diagnosing the resources of the receiver and preventing service collision is applied in order to prevent services from malfunctioning, the performance of the receiver from deteriorating or the receiver from rebooting, which would otherwise be caused by service collision in the smart receiver.
Framework for managing a request from a contents hub (media hub): The framework is applied to store and process accounting information, user information or the like, manage services and metadata, and process user authentication and service access in response to a request in mashup services.

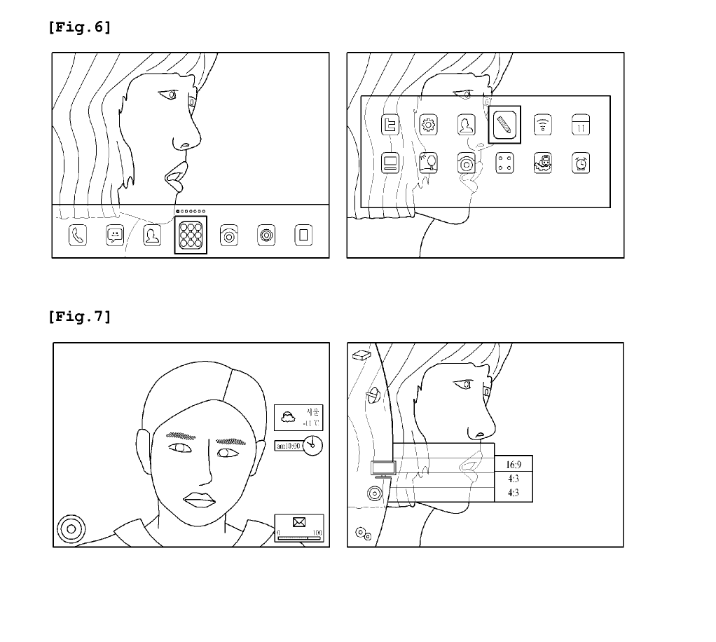

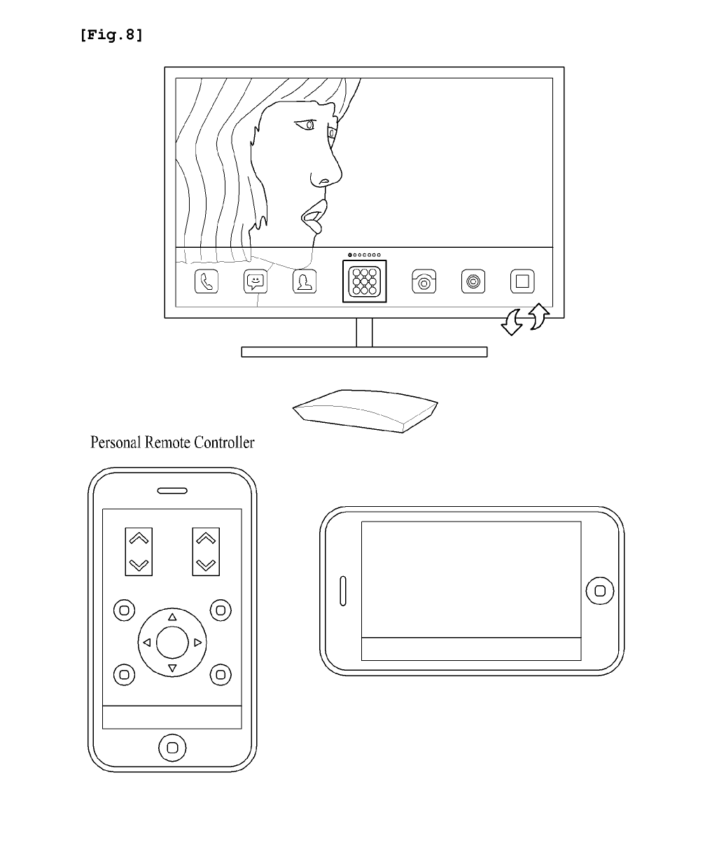

The smart receiver based on convergence as described above provides the following user interface for a smart receiver which supports a UX/UI design with which a user can easily access and use mashup services, and enables the user to use a corresponding service at any time.
Simplified home UI/UX for digital TV broadcast services: When the smart receiver is used, a basic mode is a familiar TV watching mode as in a typical TV, and a semitransparent user interface with which a smart application can be executed using a specific button, such as a Home button or an Info button. A TV watching screen is basically displayed before the smart application is completely executed. This scheme does not divide the TV watching mode and the smart application mode from each other, thereby allowing the user to easily move between the TV watching mode and the smart application. This scheme maintains the smart application mode together with the user interface of the TV with which the user is familiar with, thereby realizing the user interface in which the user can easily use the smart device. FIG. 6 shows an example of a user interface of a smart receiver application.
Smart TV watching UI/smart TV setting UI: A smart TV watching user interface and a smart TV setting user interface are supported, which can provide a widget type smart service together with basic TV functions, such as channel change and volume tuning. FIG. 7 shows an example of a user interface of a smart receiver watching screen.
Touch Interface: A touch interface is provided to a smart TV by linking a smartphone to the smart receiver. It is possible to operate the smart TV using a personalized remote controller and the smartphone in order to increase convenience. FIG. 8 shows an example in which a smartphone is used as a remote controller of a smart receiver.
Media playing application interface: This supports an application for playing image/audio contents files in the smart receiver or in an outside storage device.
Intuitive menu interface using OpenGL ES: OpenGL ES stands for OpenGL for embedded systems, and is a 3D graphics application designed for a mobile embedded device. This scheme simplifies the design by removing an application which has a low use frequency in order to optimize the embedded system. An application which is minimized and optimized considering mobile environment can be provided. Advantages of using a minimum storage space and memory are achieved, and a 3D GUI can be efficiently applied to the smart receiver. A more qualified and specialized user interface is developed by applying OpenGL ES to a menu GUI.
Software upgrade interface: It is possible to update and support newest software always by supporting various types of software upgrade (manual/automatic/scheduled). A smart TV is an expensive device, software upgrade is almost impossible when it is purchased once, and it is difficult to enjoy newest service. In contrast, it is possible to constantly receive newest software and enjoy newest services using the smart receiver.
Smart receiving application interface: This interface basically supports a direct DMB application, a direct EPG management application, a gallery image application, a video resolution setting application, a closed caption setting application and the like.

The foregoing descriptions of specific exemplary embodiments of the present invention have been presented for the purposes of illustration and description. They are not intended to be exhaustive or to limit the present invention to the precise forms disclosed, and obviously many modifications and variations are possible in light of the above teachings. The exemplary embodiments were chosen and described in order to explain certain principles of the present invention and their practical application, to thereby enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A smart receiver for a mashup services based on convergence, comprising:
a hardware platform which receives a digital broadcast and supports an added service;
a smart receiver hardware module which supports a multimedia function of the hardware platform and a mashup service; and
a smart receiver software module which supports the multimedia function and the mashup service so that a digital broadcast is received in real time via a broadcast tuner.

2. The smart receiver according to claim 1, wherein the hardware module includes an HDMI (high definition multimedia interface) port, a USB host, an Internet connection section and an S/PDIF (Sony/Philips digital interface format) output.

3. The smart receiver according to claim 1, wherein the software module supports IP network RTSP (real time streaming protocol), HTTP (hypertext transfer protocol) streaming and HLS (HTTP live streaming) type IP streaming services, a VOD (video on demand) service, an EPG (electronic program guide) service, closed captions, PSIP/SI (program and system information protocol/system information), videos and audios.

4. The smart receiver according to claim 1, wherein the smart receiver software module comprises Android operating system that is optimized, thereby improving a booting speed and a channel change speed of the smart receiver so as to match those of a digital TV, and preventing a media explorer from operating every time during booting or when data is stored.

5. The smart receiver according to claim 1, wherein the hardware platform comprises a user interface for the smart receiver for digital TV broadcast services.

6. The smart receiver according to claim 1, wherein the hardware platform comprises a framework which enables the mashup service to be used, a framework which is for management of a contents hub request, and a UI/UX (user interface/user experience design) for the mashup service.

7. The smart receiver according to claim 5, wherein the user interface for the smart receiver includes a simplified home UI/UX (user interface/user experience design), a menu interface, software upgrade, a media playing application and an application for the smart receiver.

8. The smart receiver according to claim 6, wherein the framework includes a media framework, an eco-system link framework, a UI/UX (user interface/user experience design) framework and a digital broadcast service framework.

9. The smart receiver according to claim 6, wherein the framework is provided for management of the contents hub request, and stores accounting information and user information requested in the mashup service, copes with a processing request for the accounting information and the user information, manages services, manages metadata, and manages and diagnoses resources of the smart receiver and prevents service collision by including a framework module which executes user authentication and service access, and the UI/UX (user interface/user experience design) includes an application which enables a user to use the mashup service at any time.

10. The smart receiver according to claim 7, wherein the menu interface comprises an intuitive menu interface, and the software upgrade includes at least one selected from among manual, automatic and scheduled types.

11. The smart receiver according to claim 7, wherein the application for the smart receiver has direct DMB (digital multimedia broadcasting), direct EPG (electronic program guide) management, gallery image, video resolution management and closed caption functions.

12. A smart receiving method for mashup services based on convergence, comprising:
accessing a server for the mashup service via a communication port;
supporting receiving a digital broadcast and supporting an added service using a hardware platform after accessing the server; and
supporting IP network RTSP (real time streaming protocol), HTTP (hypertext transfer protocol) streaming and HLS (HTTP live streaming) type IP streaming services, a VOD (video on demand) service, an EPG (electronic program guide) service, closed captions, PSIP/SI (program and system information protocol/system information), videos and audios using a software module of the hardware platform, so that the digital broadcast is to be received in real time.

13. The smart receiving method according to claim 12, wherein receiving the digital broadcast and supporting the added service after accessing the server comprises:
dividing meta-information for using the mashup service, processing EPG (electronic program guide) service data and displaying UI/UX (user interface/user experience design) for constructing an IP streaming channel, wherein a corresponding service is selected and mashup data is processed via the UI/UX.

14. The smart receiving method according to claim 12, comprising:
optimizing Android OS via the software module of the hardware platform to improve a booting speed and a channel change speed of a smart receiver so as to match those of a digital TV, so that a media explorer does not operate every time during booting or when data is stored;
searching for the mashup service via the UI/UX (user interface/user experience design) linked to thereto, selecting the service and accessing a server via an Internet connection section;
extracting data from a data stream received from the server via a system link framework for the mashup service, and processing authentication and accounting for the extracted data using a dedicated player; and
playing and displaying the data extracted for the mashup service using the dedicated player.

15. The smart receiving method according to claim 12, comprising:
managing, at the hardware platform, a contents hub request via a media framework, an eco-system link framework, a UI/UX (user interface/user experience design) framework and a digital broadcast service framework, and
managing, at the frameworks, resources of the smart receiver and preventing service collision by integrally controlling processes of storing accounting information and user information requested in the mashup service, coping with a processing request for the accounting information and the user information, managing metadata, and processing user authentication and service access via a framework module.

16. The smart receiving method according to claim 15, comprising controlling, by the UI/UX (user interface/user experience design) framework, a home UI/UX (user interface/user experience design), a menu interface, software upgrade, a media playing application and an application for the smart receiver,
wherein a user is allowed to use the mashup service at any time via the home UI/UX.

17. The smart receiving method according to claim 16, wherein the application for the smart receiver comprises a direct DMB (digital multimedia broadcasting) application, a direct EPG (electronic program guide) management application, a gallery image application, a video resolution management application, or a closed caption application.
